(19) United States
(12) Patent Application Publication
(10) Pub. No.: US 2004/0215873 A1
(43) Pub. Date: Oct. 28, 2004

(54) Recording and reproducing system, recording apparatus, reproducing apparatus, record medium, recording and reproducing method, recording method, reproducing method, program and record medium

(76) Inventors: Chiyoko Matsumi, Osaka (JP); Keisuke Matsuo, Nara (JP); Harutoshi Miyamoto, Osaka (JP); Nobuyasu Takeguchi, Osaka (JP); Yasuyuki Torii, Kyoto (JP); Toshihiko Mizukami, Osaka (JP); Kevin Leigh La Chapelle, Redmond, WA (US); Ian Cameron Mercer, Sammammish, WA (US)

Correspondence Address: SMITH GAMBRELL & RUSSELL LLP, Suite 800, 1850 M Street N W, Washington, DC, 20036, US

(21) Appl. No.: 10/725,929

(22) Filed: Dec. 3, 2003

Related U.S. Application Data
(60) Provisional application No. 60/433,013, filed on Dec. 13, 2002.

(51) Int. Cl. G06F 12/00

(52) U.S. Cl. 711/112

(57) ABSTRACT

[Problem] There has been a problem that there is long waiting time until reproduction of a video file and an audio file on a reproducing apparatus can be started.

[Means for Solution] A recording and reproducing system has means including a CD-RW medium 15 of holding a data file of storing predetermined data and parameter information used for reproducing the predetermined data, a file recording means 14 of recording the parameter information in a contents list information file 16 of storing the parameter information held in the CD-RW medium 15, an information extracting means 32 and a contents list information file creating means 34 and means including a file reproducing means 23 of reproducing the predetermined data stored in the data file by using the parameter information which is recorded.

DETAILED DESCRIPTION OF THE INVENTION

1. Field of the Invention

The present invention relates to a recording and reproducing system, a recording apparatus, a reproducing apparatus, a record medium, a recording and reproducing method, a program and a record medium.

2. Prior Art

To begin with, a description will be given as to configuration and operation of a reproducing apparatus in the past (refer to Japanese-Patent Laid-Open No. 2000-235780 for instance) of reproducing data files such as a video file having video data and an audio file having audio data.

The data files such as the video file and audio file are recorded on a record medium such as a CD-ROM (Compact Disk-Read Only Memory) according to a predetermined file system.

To reproduce the files, it is necessary to analyze the file system of the record medium, obtain file names of the data files recorded on the record medium, obtain information required for getting access to the files such as a recording position on the record medium and a file size as to each of the files, and reproduce desired data files by means of file access.

As a matter of course, it is also feasible to obtain the information required for getting access to the data file to be reproduced each time the file is selected.

However, as for the reproducing apparatus in the past of which performance is not high, it is normal that a time-consuming analysis of the file system is performed at the time of having the record medium inserted in a drive, and the information required for getting access to the data files is obtained piece by piece and stored in a memory as to each of reproducible data files. Moreover, the reason for thus obtaining the information required for getting access to the data file on startup is that, if the file system is analyzed to obtain the information on the recording position and file size each time access is made, this process takes time.

However, as for the reproducing apparatus in the past, the time-consuming analysis of the file system is performed at the time of having the record medium inserted in the drive, and the information required for getting access to the data files is obtained piece by piece as to each of reproducible data files, so that there was a problem that there is long waiting time until reproduction of the video file and audio file on the reproducing apparatus can be started.

### MEANS TO SOLVE THE PROBLEMS

In consideration of the above problem in the past, an object of the present invention is to provide a recording and reproducing system, a recording apparatus, a reproducing apparatus, a record medium, a recording and reproducing method, a program and a record medium capable of shortening waiting time until reproduction of a video file and an audio file on the reproducing apparatus can be started.

The 1^{st} aspect of the present invention is a recording and reproducing system, comprising:

a record medium (15) for holding a data file (13) for storing predetermined data and parameter information used to reproduce said predetermined data;

parameter information recording means (14, 32, 34) of recording said parameter information in a parameter information file (16) for storing said parameter information held in said record medium (15); and

data reproducing means (23) of reproducing the predetermined data stored in said data file (13) by using said recorded parameter information.

The 2^{nd} aspect of the present invention is the recording and reproducing system according to the 2^{nd} aspect of the present invention, wherein said parameter information recording means (14, 32, 34) extracts the parameter information from said data file (13) and records the extracted parameter information in said parameter information file (16).

The 3^{rd} aspect of the present invention is the recording and reproducing system according to the 1^{st} aspect of the present invention, wherein the parameter information stored in said data file (13) is also stored in a predetermined location, and said parameter information recording means (14, 32, 34) obtains said parameter information also stored in the predetermined location and records the obtained parameter information in said parameter information file (16).

The 4^{th} aspect of the present invention is the recording and reproducing system according to any one of the 1^{st} to the 3^{rd} aspects of the present invention, wherein said record medium (15) holds a plurality of said data files (13), and said parameter information file (16) stores all of the parameter information stored in said plurality of data files (13) respectively.

The 5^{th} aspect of the present invention is the recording and reproducing system according to the 4^{th} aspect of the present invention, wherein said plurality of data files (13) are given unique data file IDs respectively by using order in which said parameter information file (16) stores said parameter information.

The 6^{th} aspect of the present invention is the recording and reproducing system according to the 5^{th} aspect of the present invention, wherein said data files (13) have positions in which they are held by said record medium (15) managed by using said given unique data file IDs.

The 7^{th} aspect of the present invention is the recording and reproducing system according to the 4^{th} aspect of the present invention, wherein said parameter information file (16) stores the parameter information stored in said plurality of data files (13) respectively by using classification according to a type of said predetermined data.

The 8^{th} aspect of the present invention is the recording and reproducing system according to any one of the 1^{st} to the 3^{rd} aspects of the present invention, wherein said data file (13) further stores meta-data information on said predetermined data, and meta-data information recording means (14, 32, 33) of recording said meta-data information in a meta-data information file (17) for storing said meta-data information held in said record medium is further provided.

The 9^{th} aspect of the present invention is a recording apparatus, comprising: parameter information recording means of recording parameter information in a parameter information file for storing said parameter information, said file held in a record medium for holding a data file for storing predetermined data and said parameter information used to reproduce said predetermined data,

wherein the predetermined data stored in said data file is reproduced by using said recorded parameter information.

The 10^{th} aspect of the present invention is a reproducing apparatus, comprising: data reproducing means of reproducing predetermined data stored in a data file by using parameter information recorded in a parameter information file held by a record medium for holding said data file for storing the predetermined data and the parameter information used to reproduce said predetermined data and the parameter information file for storing said parameter information.

The 11^{th} aspect of the present invention is a record medium for holding a data file for storing predetermined data and parameter information used to reproduce said predetermined data and a parameter information file for storing said parameter information,

wherein said parameter information is recorded in said parameter information file, and

the predetermined data stored in said data file is reproduced by using the parameter information stored in said parameter information file.

The 12^{th} aspect of the present invention is a recording and reproducing method, comprising:

a parameter information recording step of recording parameter information in a parameter information file held by a record medium for holding a data file for storing predetermined data and the parameter information used to reproduce said predetermined data and a parameter information file for storing said parameter information; and

a data reproducing step of reproducing the predetermined data stored in said data file by using said recorded parameter information.

The 13^{th} aspect of the present invention is a recording method comprising a parameter information recording step of recording parameter information in a parameter information file for storing said parameter information held by a record medium for holding a data file for storing predetermined data and said parameter information used to reproduce said predetermined data,

wherein the predetermined data stored in said data file is reproduced by using said recorded parameter information.

The 14^{th} aspect of the present invention is a reproducing method comprising a data reproducing step of reproducing predetermined data stored in a data file by using parameter information recorded in a parameter information file held by a record medium for holding said data file for storing the predetermined data and the parameter information used to reproduce said predetermined data and the parameter information file for storing said parameter information.

The 15^{th} aspect of the present invention is a program for causing a computer to execute parameter information recording step and data reproducing step of a recording and reproducing method according to the 12^{th} aspect of the present invention.

The 16^{th} aspect of the present invention is a program for causing a computer to execute a parameter information recording step of a recording method according to the 13^{th} aspect of the present invention.

The 17^{th} aspect of the present invention is a program for causing a computer to execute a data reproducing step of a reproducing method according to the 14^{th} aspect of the present invention.

The 18^{th} aspect of the present invention is a medium supporting a program according to the 15^{th} aspect of the present invention and processable by a computer.

The 19^{th} aspect of the present invention is a medium supporting a program according to the 16^{th} aspect of the present invention and processable by a computer.

The 20^{th} aspect of the present invention is a medium supporting a program according to the 17^{th} aspect of the present invention and processable by a computer.

### BRIEF DESCRIPTION OF THE DRAWINGS

FIG. 1 is a block diagram of a recording and reproducing system according to a first embodiment of the present invention.

FIG. 2 is an explanatory diagram of a data storage format of a contents list information file 16 according to the first embodiment of the present invention.

FIG. 3 is an explanatory diagram of the data storage format of a meta-data information file 17 according to the first embodiment of the present invention.

FIG. 4 is an explanatory diagram of a display screen (1) according to the first embodiment of the present invention.

FIG. 5 is an explanatory diagram of a display screen (2) according to the first embodiment of the present invention.

FIG. 6 is a block diagram of a reproducing apparatus according to an embodiment of the present invention.

FIG. 7 is a block diagram of a recording apparatus according to an embodiment of the present invention.

### DESCRIPTION OF THE REFERENCE NUMERALS

10 Recording apparatus

11 Write file management means

12 Internal storage means

13 Data file group

14 File recording means

15 CD-RW medium

16 Contents list information file

17 Meta-data information file

20 Reproducing apparatus

21 Controlling means

22 Reproduction instructing means (remote control)

23 File reproducing means

24 Data file output means

31 Write file selecting means

32 Information extracting means

33 Meta-data information file creating means

34 Contents list information file creating means

### PREFERRED EMBODIMENTS OF THE INVENTION

Hereafter, embodiments of the present invention will be described by referring to the drawings.

### First Embodiment

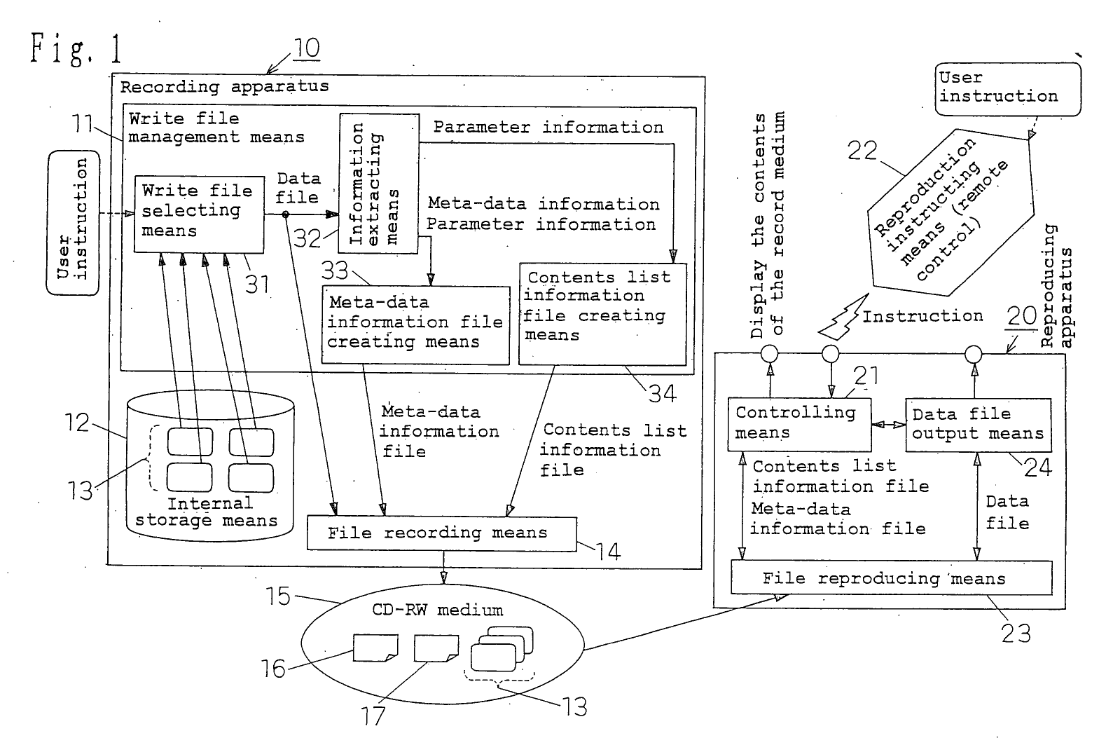

To begin with, configuration of a recording and reproducing system according to a first embodiment of the present invention will be described by referring to FIG. 1 which is a block diagram thereof.

A recording apparatus 10 has (1) write file management means 11 having write file selecting means 31, information extracting means 32, meta-data information file creating means 33 and contents list information file creating means 34, (2) internal storage means 12 of storing a data file group 13, and (3) a file recording means 14 of recording on a CD-RW (Compact Disk Rewritable) medium 15 storing the data file group 13, contents list information file 16 and meta-data information file 17.

To be more specific, the write file management means 11 has a CPU (Central Processing Unit) and so on. In addition, the internal storage means 12 has an HD (Hard Disk) and so on. In addition, the file recording means 14 has a CD-RW drive and so on.

The contents list information file 16 and meta-data information file 17 will be described in detail later.

A reproducing apparatus 20 has (1) controlling means 21 of inputting an instruction provided by reproduction instructing means (remote control) 22 and exerting control, (2) file reproducing means 23 of performing reproduction from the CD-RW medium 15, and (3) data file output means 24.

To be more specific, the controlling means 21 has a CPU and so on. In addition, the file reproducing means 23 has a CD-RW drive and so on. In addition, the data file output means 24 has a decoder and so on.

Here, the contents list information file 16 and meta-data information file 17 will be described in detail.

First, (A) the contents list information file 16 and then (B) the meta-data information file 17 will be described.

(A) The contents list information file 16 stores unique parameter information defining the data files (that is, audio files #1, . . . , #n, static image files #1, . . . , #m, and video files #1, . . . , #k) themselves belonging to the data file group 13, of the information duplicately extracted by the information extracting means 32.

The parameter information is the information necessary to perform the reproduction of the data files on the CD-RW medium 15. Here, the information necessary to perform the reproduction of the data files is as follows. (1) As for the audio files (that is, the audio files #1, . . . , #n), sampling frequency information, channel number information, compression method (encode) information, play duration information, data rate information and so on of defining the audio file which is stored as header information in the AVI (Audio Video Interleave) file format, WMA (Windows Media Audio) file format and ASF (Advanced Systems Format) file format, (2) as for the static image files (that is, the static image files #1, . . . , #m), compression method information, image size information and so on of defining the static image file stored as the header information in the JPEG (Joint Picture Expert Group) file format, and (3) as for video files (that is, the video files #1, . . . , #k), image size information, frame rate information, data rate information, compression method information, reproduction duration information and so on of defining the video file stored as the header information in the AVI file format, WMV (Windows Media Video) file format and ASF file format.

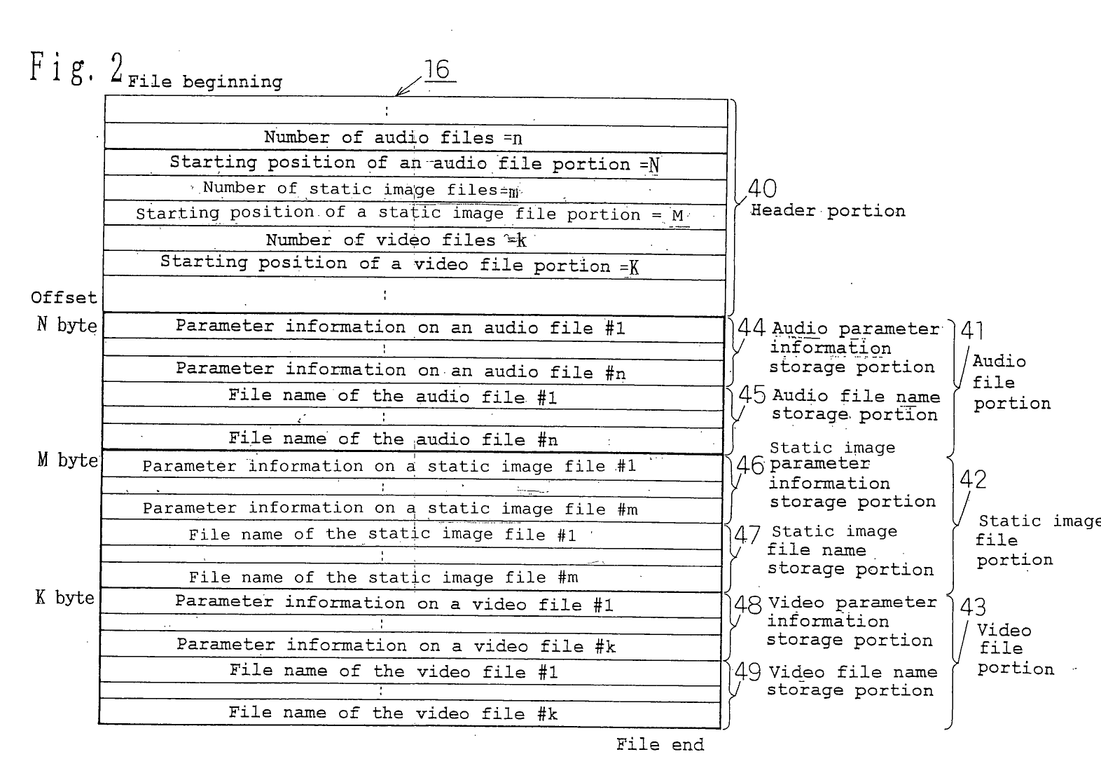

Here, the contents list information file 16 according to the first embodiment of the present invention will be described further in detail by referring to FIG. 2 which is an explanatory diagram of a data storage format thereof.

The contents list information file 16 is comprised of a header portion 40, an audio file portion 41, a static image file portion 42 and a video file portion 43.

The header portion 40 stores the numbers of the audio files, static image files and video files belonging to the data file group 13 which are n, m and k pieces respectively. In addition, the header portion 40 stores starting positions (that is, the byte numbers of offsets from file heads) of the audio file portion 41 comprised of n pieces of information on the audio files #1, . . . , #n, the static image file portion 42 comprised of m pieces of information on the static image files #1, . . . , #m, and the video file portion 43 comprised of k pieces of information on the video files #1, . . . , #k, which are N bytes, M bytes and K bytes, respectively.

The audio file portion 41 is comprised of an audio parameter. information storage portion 44 and an audio file name storage portion 45.

The audio parameter information storage portion 44 stores in order the parameter information extracted from each of the audio files #1, . . . , #n, and the audio file name storage portion 45 stores in order the file names of each of the audio files #1, . . . , #n.

The audio files #1, . . . , #n have contents IDs=1, . . . , n assigned thereto according to serial storage order through the audio files, static image files and video files of which parameter information is stored in the contents list information file 16.

The static image file portion 42 is comprised of a static image parameter information storage portion 46 and a static image file name storage portion 47.

The static image parameter information storage portion 46 stores in order the parameter information extracted from each of the static image files #1, . . . , #m, and the static image file name storage portion 47 stores in order the file names of each of the static image files #1, . . . , #m.

The static image files #1, . . . , #m have contents IDs=n+1, . . . , n+m assigned thereto according to the aforementioned serial storage order.

The video file portion 43 is comprised of a video parameter information storage portion 48 and a video file name storage portion 49.

The video parameter information storage portion 48 stores in order the parameter information extracted from each of the video files #1, . . . , #k, and the video filename storage portion 49 stores in order the file names of each of the video files #1, . . . , #k.

The video files #1, . . . , #k have contents IDs=n+m+1, . . . , n+m+k assigned thereto according to the aforementioned serial storage order.

(B) The meta-data information file 17 stores meta-data information of supplementally describing the contents of the data files belonging to the data file group 13, of the information extracted by the information extracting means 32.

The meta-data information includes the following. (1) As for the audio files (that is, the audio files #1, . . . , #n), text information on a composer, a musician, lyrics, a contents name and so on, image information on a photo of an album jacket and so on at an ID3 tag in an MP3 file format, (2) as for the static image files (that is, the static image files #1, . . . , #m), the text information on shooting situation, a camera used for shooting such as an Exif (Exchange Image File Format) on the JPEG file format and so on, and (3) as for video files (that is, the video files #1, . . . , #k), the text information on the contents name, outline of a TV program and so on.

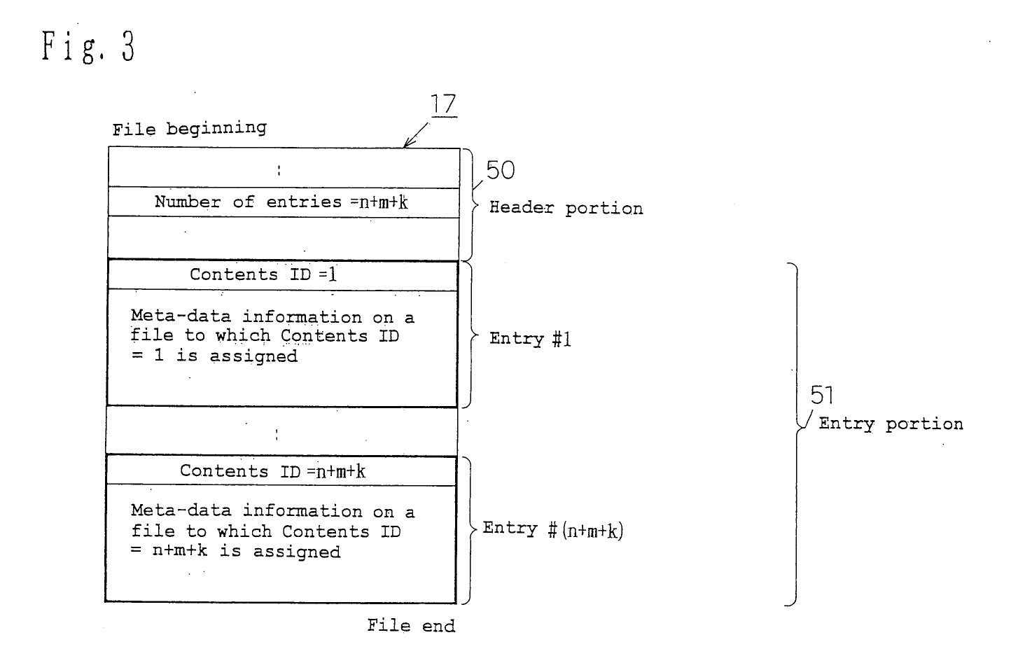

Here, the contents list information file 16 will be described further in detail by referring to FIG. 3 which is an explanatory diagram of a data storage format of the meta-data information file 17 according to the first embodiment of the present invention.

The meta-data information file 17 is comprised of a header portion 50 and an entry portion 51.

The header portion 50 stores the number of entries (that is, entries #1, . . . , # (n+m+k)) stored in the entry portion 51 which is (n+m+k) pieces. The number of the entries stored in the entry portion 51 matches with the number of all the aforementioned files of which parameter information is stored in the contents list information file 16.

The entry portion 51 stores entries #1, . . . , # (n+m+k) The entries #1, . . . , # (n+m+k) store the contents IDs of corresponding files and the meta-data information on the files to which the contents IDs are assigned respectively. For instance, the entry #1 has the contents ID=1 and the meta-data information on the file to which the contents ID=1 is assigned stored therein.

The configuration of the recording and reproducing system according to this embodiment was described in detail above.

Next, operation of the recording and reproducing system according to this embodiment will be described.

Moreover, an embodiment of the recording and reproducing method-, recording method and reproducing method according to the present invention will also be described while describing the operation of the recording and reproducing system according to this embodiment.

\mathring{1} To begin with, a description will be given as to the operation of the recording apparatus 10 of recording the data files of the data file group 13 (that is, the audio files #1, . . . , #n, static image files #1, . . . , #m and video files #1, . . . , #k) on the CD-RW medium 15.

The write file selecting means 31 follows an instruction provided by a user to the effect that “the data file of the data file group 13 should be recorded on the CD-RW medium 15,” and selects the data file of the data file group 13 to be recorded on the CD-RW medium 15, of the data files of the data file group 13 stored in the internal storage means 12.

The information extracting means 32 duplicately extracts the information related to the stored data file from the data file of the data file group 13 selected by the write file selecting means 31.

The contents list information file creating means 34 creates the contents list information file 16 by using the parameter information extracted by the information extracting means 32.

As previously mentioned, the data files of which parameter information is stored in the contents list information file 16 have contents IDs=1, . . . , n assigned thereto according to the serial storage order through all such data files.

The meta-data information file creating means 33 creates the meta-data information file 17 by using the parameter information and meta-data-information extracted by the information extracting means 32.

The file recording means 14 records the data file of the data file group 13 selected by the write file selecting means 31 on the CD-RW medium 15, and also records thereon the contents list information file 16 created by the contents list information file creating means 34 and the meta-data information file 17 created by the meta-data information file creating means 33.

As a matter of course, the contents list information file 16 thus created on the CD-RW medium 15 may be updated by being overwritten with the parameter information of another data file as write-once.

In addition, the meta-data information file 17 thus created on the CD-RW medium 15 may be updated by being overwritten with the meta-data information of another data file as write-once.

\mathring{2} Next, the operation of the reproducing apparatus 20 of reproducing the data file recorded on the CD-RW medium 15 will be described.

The reproduction instructing means 22 follows an instruction provided by the user to the effect that “the file recorded on the CD-RW medium 15 should be reproduced,” and instructs the controlling means 21 likewise.

The controlling means 21 follows the instruction provided by the reproduction instructing means 22, and instructs the file reproducing means 23 likewise.

The file reproducing means 23 follows the instruction provided by the controlling means 21, and reads the contents of the contents list information file 16 recorded on the CD-RW medium 15.

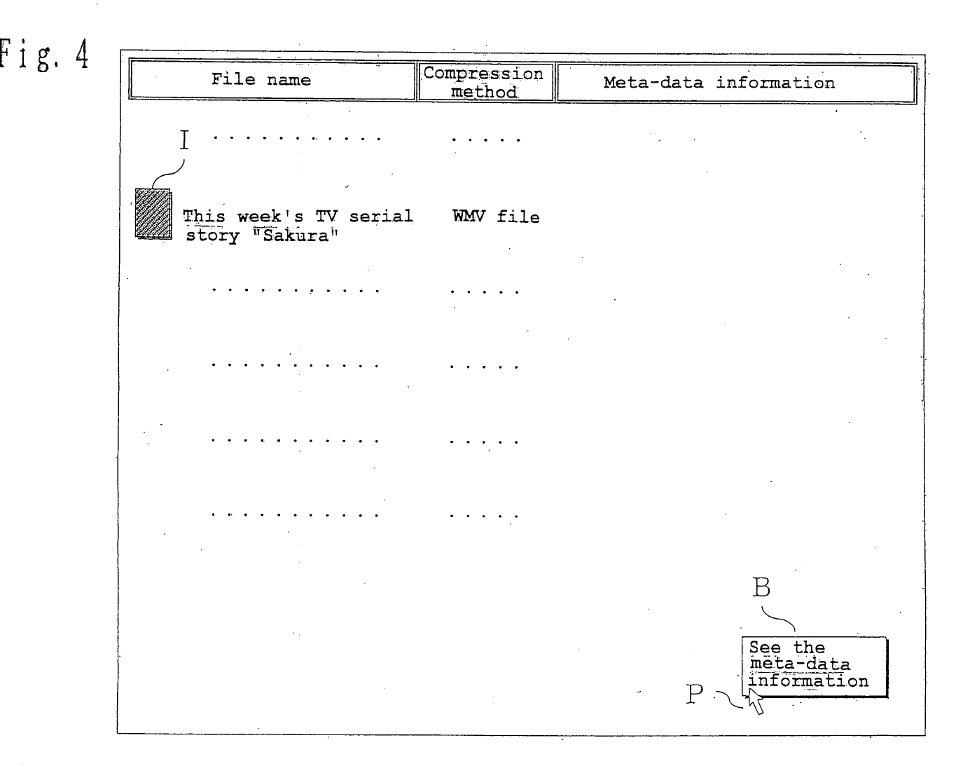

The controlling means 21 interprets the contents of the contents list information file 16 which was read, and outputs to the user a display screen as shown in FIG. 4 which is an explanatory diagram of the display screen (1) according to the first embodiment of the present invention by using a display device (not shown).

As all the above-mentioned parameter information is written in the contents list information file 16, such operation is performed at high speed without an analysis of a file system or file access to individual files.

As a matter of course, reading of the contents list information file 16 is performed by analyzing the file system and obtaining a recording position thereof as with the reading of the file system in the past.

\mathring{3} Next, the operation of the reproducing apparatus 20 of displaying the meta-data information will be described.

The reproduction instructing means 22 follows an instruction provided by the user having seen the display screen by clicking on a button B with a pointer P to the effect that “the meta-data information should be displayed,” and instructs the controlling means 21 likewise.

The controlling means 21 follows the instruction provided by the reproduction instructing means 22, and instructs the file reproducing means 23 likewise.

The file reproducing means 23 follows the instruction provided by the controlling means 21, and reads the contents of the meta-data information file 17 recorded on the CD-RW medium 15.

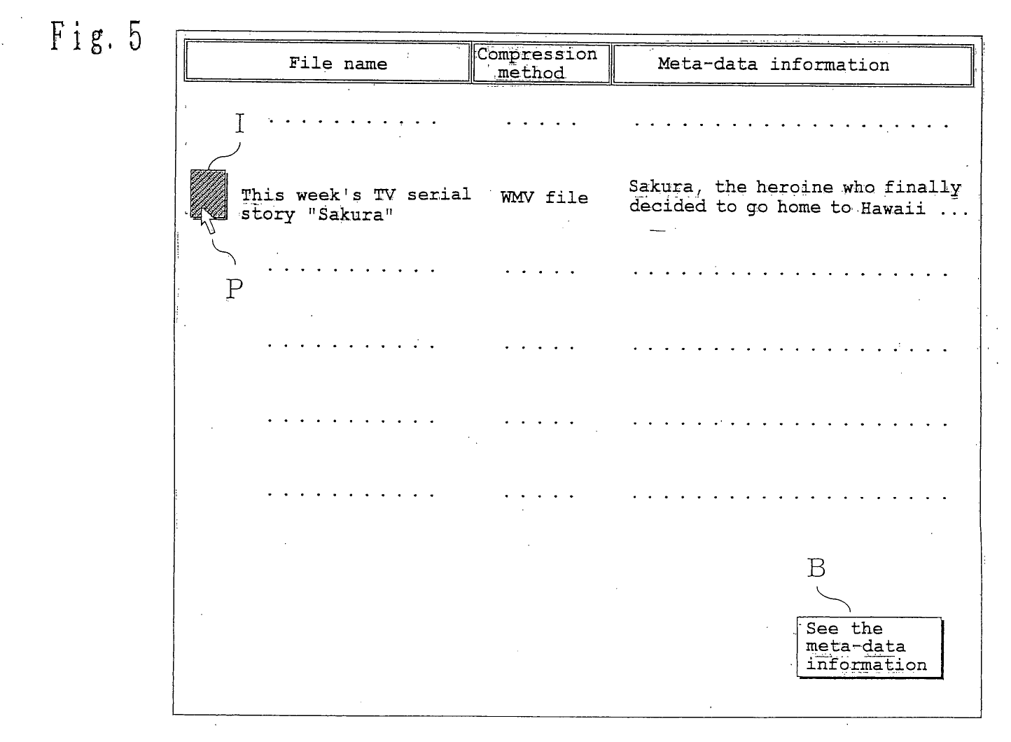

The controlling means 21 interprets the contents of the meta-data information file 17 which was read, and outputs to the user the display screen as shown in FIG. 5 which is an explanatory diagram of the display screen (2) according to the first embodiment of the present invention by using the display device (not shown).

As all the above-mentioned meta-data information is written in the meta-data information file 17, such operation is performed at high speed without the analysis of the file system or the file access to individual files.

As a matter of course, reading of the meta-data information file 17 is performed by analyzing the file system and obtaining the recording position thereof as with the reading of the file system in the past.

\mathring{4} Next, the operation of the reproducing apparatus 20 of reproducing the file recorded on the CD-RW medium 15 will be described.

The reproduction instructing means 22 follows an instruction provided by the user having seen the display screen by clicking on an icon I with a pointer P to the effect that “the data file of which file name is “this week's TV serial story ‘Sakura'” should be reproduced,” and instructs the controlling means 21 likewise.

The file reproducing means 23 follows the instruction provided by the controlling means 21, and reads the contents of the contents list information file 16 recorded on the CD-RW medium 15.

The controlling means 21 provides an instruction to the file reproducing means 23 to the following effect. (1) To interpret the contents of the contents list information file 16 which was read, (2) recognize that the file of which file name is “this week's TV serial story ‘Sakura’” is a video file #1 having the contents ID=n+m+1, and (3) reproduce the video file #1 having the contents ID=n+m+1 based on the parameter information of the video file #1.

As all the above-mentioned parameter information is written in the contents list information file 16, such operation is performed at high speed without the analysis of the file system or the file access to individual files.

The file reproducing means 23 follows the instruction provided by the controlling means 21, and reads the contents of the video file #1 having the contents ID=n+m+1 recorded on the CD-RW medium 15.

The data file output means 24 utilizes format conversion from a file format to an output format to output the contents of the video file #1 having the contents ID=n+m+1 which was read.

The operation of the recording and reproducing system according to this embodiment was described in detail above.

Next, the effects of the recording and reproducing system according to this embodiment will be described.

(a) The recording and reproducing system according to this embodiment identifies a reproducible file from the stored parameter information just by reading the contents list information file 16.

For this reason, the recording and reproducing system according to this embodiment does not need to read the data and fully check whether or not it is in a reproducible data format as to all the files, but it can easily present to the user only the files in an reproducible data format and have a file to be reproduced selected thereof by the user.

(b) The recording and reproducing system according to this embodiment collectively records the text information related to the contents of the file in the meta-data information file 17.

For this reason, the recording and reproducing system according to this embodiment can easily display the text information related to each file just by reading the meta-data information file 17.

As a matter of course, as for the recording and reproducing system according to this embodiment, it is also feasible to additionally implement functions of briefly grasping the contents of each file or of searching criteria by exploiting such text information.

(c) Moreover, as for a filename length, ISO (International Standard Organization) 9660 Joliet expansion specification prescribes it to be as large as maximum 128 bytes. As a matter of course, such a file name length becomes even larger when a path name is included.

The recording and reproducing system according to this embodiment does not store the text information extracted from the file in the meta-data information file 17 by directly associating it with the file name, but stores it therein by associating it with the contents ID. As a matter of course, the contents ID is uniquely associated with the file name by using the contents list information file 16.

A 32-bit ID may be used as the contents ID for instance, which is sufficiently small compared to a data size of the file name.

For this reason, the recording and reproducing system according to this embodiment can render the size of the meta-data information file 17 small so as to effectively exploit the capacity of the CD-RW medium 15 for the sake of recording the video files and audio files as originally intended.

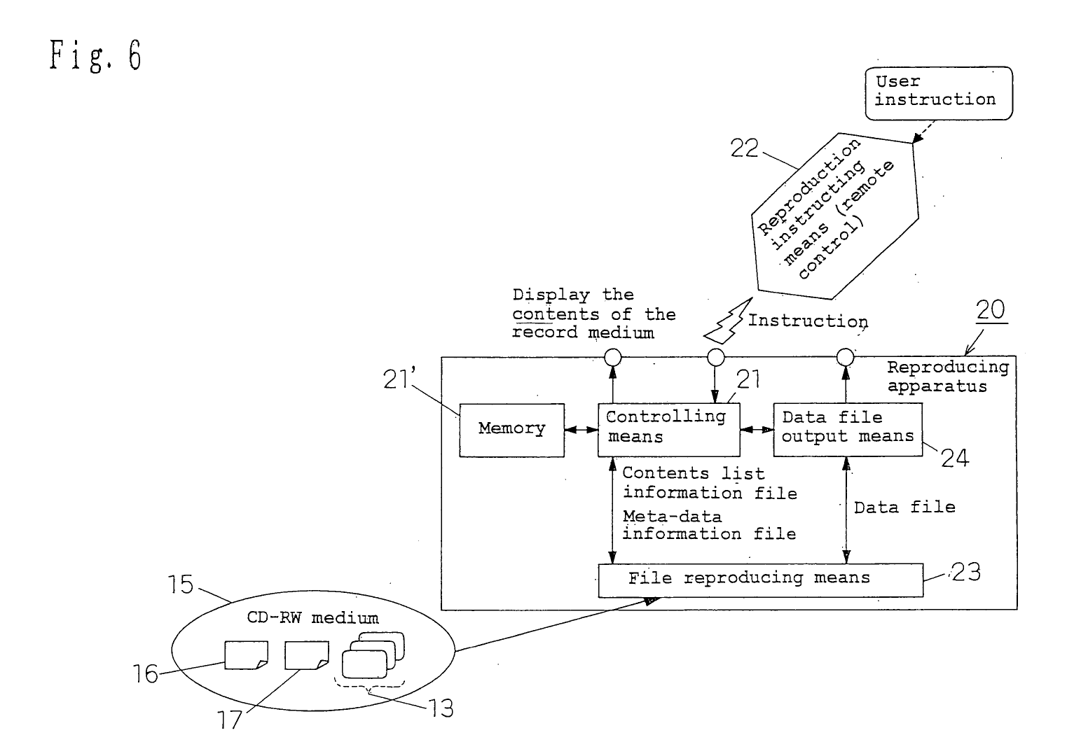

(d) Incidentally, the contents of the contents list information file 16 which was read in order to perform the reproduction become necessary when the user selects the file to be reproduced, and so they are stored in a built-in memory 21′ in reality as shown in FIG. 6 which is a block diagram of the reproducing apparatus according to an embodiment of the present invention.

On the other hand, the contents of the meta-data information file 17 are not essential to the reproduction of data, and so they do not need to be stored in the memory 21′ but may be read from the CD-RW medium 15 as required.

The recording and reproducing system according to this embodiment stores such a meta-data information file 17 as a file separate from the contents list information file 16.

For this reason, the recording and reproducing system according to this embodiment can realize an inexpensive product of which size of the memory 21′ is rendered small.

(e) Moreover, the recording and reproducing system according to this embodiment classifies the files by the data formats such as the audio, staic image and video, and stores the starting positions of specifying storage positions of the respective classes in the header portion 40 of the contents list information file 16.

For instance, in the case where the data file output means 24 can only reproduce the audio files, only the audio file portion 41 is read based on the information of the header portion 40 and is stored in the memory 21′ (refer to FIG. 6) when reading the contents list information file 16, and the static image file portion 42 and video file portion 43 are not read then.

For this reason, the recording and reproducing system according to this embodiment shortens time of a reading process and holds down the amount of the memory 21′ of storing the read data so that it can realize the inexpensive product of good response.

(f) In addition, the recording and reproducing system according to this embodiment manages the positions at which the data files of the data file group 13 are held by the CD-RW medium 15 by using the contents IDs instead of the file names.

To be more specific, once the recording and reproducing system according to this embodiment stores the contents list information file 16 in the memory 21′ (refer to FIG. 6) and completely obtains the recording positions of the data files for the sake of shortening the time of the reading process, it erases from the memory 21′ the information on the file names in the contents list information file 16 by taking advantage of the fact that the parameter information and file names are separated in the audio file portion 41 and so on. And the recording and reproducing system according to this embodiment manages the recording positions of the data files by using the contents IDs.

For this reason, compared to the recording and reproducing system in the past of storing the recording positions of the files associated with the file names in the memory, the recording and reproducing system according to this embodiment holds down the amount of the memory 21′ of storing the read data, so that it can realize the inexpensive product of good response.

(g) In addition, the format of the contents list information file 16 has necessary padding data inserted therein so that all the values of the aforementioned N, M and K of indicating the starting positions of the audio file portion 41, the static image file portion 42 and the video file portion 43 become the multiples of 2048 bytes.

Insertion of such padding data has the following effect.

The data recorded on the CD-RW medium 15 is delimited by 2048 bytes, and is handled as a concept called a sector. And the reading of the data from the contents list information file 16 is performed, by specifying the sector at the starting position, from the head of the sector. As the padding data is inserted so that the values of N, M and K become the multiples of 2048 bytes, the audio file portion 41, the static image file portion 42 and the video file portion 43 are also started just from the heads of the sectors.

Incidentally, the reproducing apparatus 20 (refer to FIG. 6) reads the entire contents list information file 16 and holds it in a work memory (not shown) so as to selectively take out necessary information and store it in the memory 21′. In the case where the capacity of the work memory is small, however, the reproducing apparatus 20 (refer to FIG. 6) divides the contents list information file 16, stores necessary information taken out by reading a part thereof in the memory 21′, and reading a part from the remaining part again, thus repeating the same process until all the data in the contents list information file 16 is read.

As the padding data is inserted so that the N, M and K become the multiples of 2048 bytes, even in the case where the capacity of the work memory is small and the contents list information file 16 must be divided and read, the audio file portion 41, the static image file portion 42 and the video file portion 43 can be read as-is from the heads by specifying the sectors to read them. It is not necessary to be at the trouble of analyzing and looking for the head positions of the audio file portion 41, the static image file portion 42 and the video file portion 43 thus read, and so the processing can be reduced so as to realize the inexpensive product of good response.

The first embodiment was described in detail above.

(1) Moreover, the parameter information file of the present invention is the contents list information file 16 in the above-mentioned embodiment.

However, a parameter information file of the present invention is not limited thereto, but in short, it may be any file to be held by a record medium for the sake of storing the parameter information.

(2) In addition, a data file ID of the present invention is the contents ID in the above-mentioned embodiment.

However, the data file ID of the present invention is not limited thereto, but in short, it may be any unique ID to be provided to each of a plurality of data files by using the order in which the parameter information file stores the parameter information.

(3) In addition, the record medium of the present invention is the CD-RW medium 15 in the above-mentioned embodiment.

However, the record medium of the present invention is not limited thereto, but in short, it may be a removable medium such as a CD-R (Compact Disk-Recordable) medium, or a DVD-R (Digital Versatile Disk-Recordable) medium, or a built-in storage apparatus such as an HDD (Hard Disk Drive) built into the recording apparatus or reproducing apparatus.

In short, the record medium of the present invention has only to be the means of holding the data file of storing predetermined data and the parameter information used for reproducing the predetermined data and the parameter information file of storing the parameter information.

(4) In addition, according to the above-mentioned embodiment, parameter information recording means of the present invention is the means including the file recording means 14, the information extracting means 32 and the contents list information file creating means 34 of recording the parameter information extracted from the data file of the data file group 13 in the contents list information file 16.

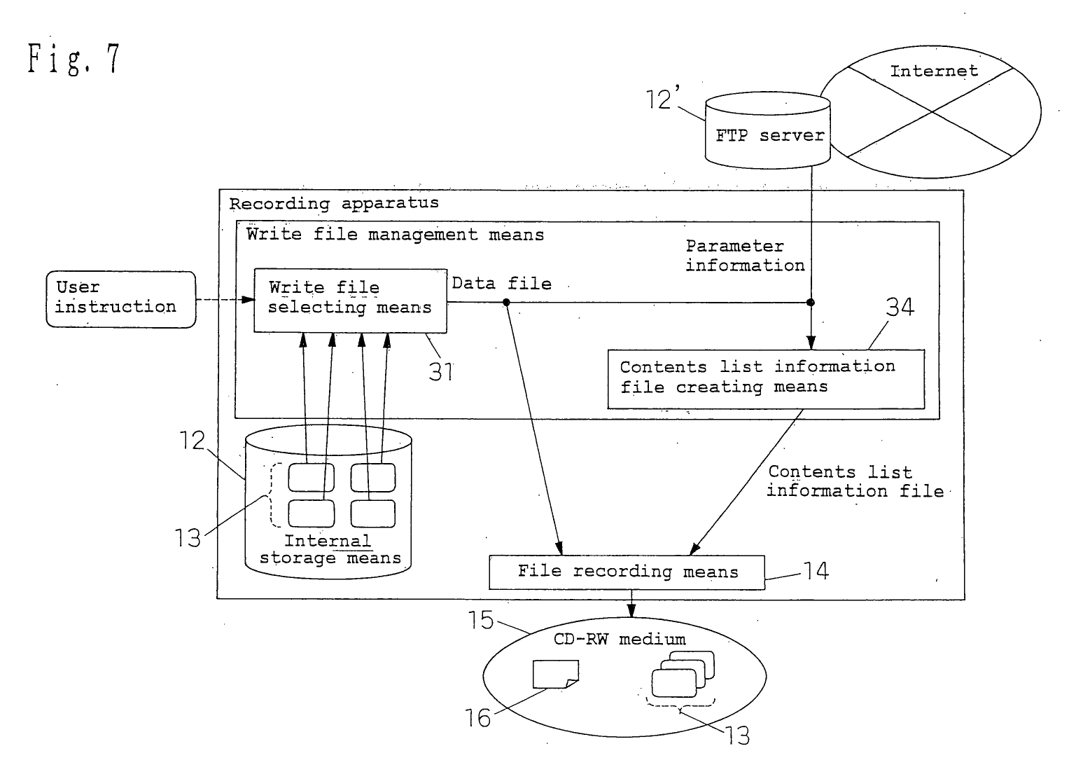

However, the parameter information recording means of the present invention is not limited thereto. As shown in FIG. 7 which is a block diagram of the recording apparatus according to an embodiment of the present invention, the parameter information stored in the data file of the data file group 13 is also stored in a predetermined place such as an FTP (File Transfer Protocol) server 12′ on the Internet, and so the parameter information recording means of the present invention may also be the means of obtaining the parameter information stored in the predetermined place and recording the obtained parameter information in the contents list information file 16. In such a case, it is not necessary to extract the parameter information from the data file so that the configuration of the reproducing apparatus is simplified.

In short, the parameter information recording means of the present invention has only to be the means of recording the parameter information in the parameter information file to be held by the record medium for the sake of storing the parameter information.

(5) In addition, according to the above-mentioned embodiment, data reproducing means of the present invention is the means including the file reproducing means 23.

However, the data reproducing means of the present invention is not limited thereto, but in short, it may be any means of reproducing the predetermined data stored in the data file by using the recorded parameter information.

(6) In addition, according to the above-mentioned embodiment, meta-data information recording means of the present invention is the means including the file recording means 14, the information extracting means 32 and the meta-data information file creating means 33 of extracting the parameter information and meta-data information from the data file of the data file group 13 and recording the extracted parameter information and meta-data information in the meta-data information file 17.

However, the meta-data information recording means of the present invention is not limited thereto, but it may also be the means of obtaining the parameter information and meta-data information by utilizing file download by way of the Internet or data input by the user's manual operation for instance and recording the obtained parameter information and meta-data information in the meta-data information file 17.

In short, the meta-data information recording means of the present invention has only to be the means of recording the meta-data information in the meta-data information file to be held by the record medium for the sake of storing the meta-data information.

(7) In addition, according to the above-mentioned embodiment, the reproduction of the predetermined data of the present invention is performed by using the file name “this week's TV serial story ‘Sakura’.”

However, the reproduction of the predetermined data of the present invention is not limited thereto, but it may also be performed by using the information on contents names and so on stored in the meta-data information file 17, and may also be performed by using the contents IDs associated with such contents names.

As a matter of course, such file names and so on may be displayed by using a dedicated display device or by sharing the display device of displaying output of the data file output means 24.

(8) In addition, according to the above-mentioned embodiment, the reproduction of the predetermined data of the present invention is started by using the instruction of the reproduction instructing means (remote control) 22.

However, the reproduction of the predetermined data of the present invention is not limited thereto, but it may also be started by using the instruction of a panel and so on mounted on the device proper for instance, and (in the case of no aforementioned instruction) may also be automatically started by using the contents IDs=1, . . . , n in order of storage of the parameter information stored in the contents list information file 16.

(9) In addition, according to the above-mentioned embodiment, the data file of the present invention is the data file of the data file group 13 stored in the internal storage means 12.

However, the data file of the present invention is not limited thereto, but it may also be the data file of the data file group recorded on the CD-RW medium 15 for instance.

It is also possible, by using the recording apparatus of the present invention, to append the contents list information file of the present invention to the CD-RW medium having the data file recorded thereon by a recording apparatus in the past, and the CD-RW medium to which the contents list information file is thus appended can perform the reproduction by using the contents list information file with the recording apparatus of the present invention. Therefore, assets of the record medium created so far can also be effectively exploited.

Moreover, the program of the present invention is the program of having the functions of all or a part of the means (or apparatuses, elements and so on) of the above-mentioned recording and reproducing system, recording apparatus and reproducing apparatus of the present invention executed by a computer, which is the program operating in synergy with the computer.

In addition, the program of the present invention is the program of having the operations of all or a part of the steps (or processes, workings, actions and so on) of the above-mentioned recording and reproducing method, recording method and reproducing method of the present invention executed by the computer, which is the program operating in synergy with the computer.

In addition, the record medium of the present invention is the record medium supporting the program of having all or a part of the functions of all or a part of the means (or apparatuses, elements and so on) of the above-mentioned recording and reproducing system, recording apparatus and reproducing apparatus of the present invention executed by the computer, which is the record medium readable by the computer and having the above described functions performed by the above described program which is read in synergy with the above described computer.

In addition, the record medium of the present invention is the record medium supporting the program of having all or a part of the operations of all or a part of the steps (or processes, workings, actions and so on) of the above-mentioned recording and reproducing method, recording method and reproducing method of the present invention executed by the computer, which is the record medium readable by the computer and having the above described operations performed by the above described program which is read in synergy with the above described computer.

In addition, the record medium of the present invention is the record medium supporting a data structure utilized in synergy with the computer in all or a part of the means (or apparatuses, elements and so on) and the steps (or processes, workings, actions and so on) of the above-mentioned recording and reproducing system, recording apparatus, reproducing apparatus, recording and reproducing method, recording method and reproducing method of the present invention, which is the record medium readable by the computer and having the above described data structure which is read utilized in synergy with the above described computer.

Moreover, the above “part of the means (or apparatuses, elements and so on)” of the present invention means one or a few of such a plurality of means, and the above “part of the steps (or processes, workings, actions and so on)” of the present invention means one or a few of such a plurality of steps.

In addition, the above “functions of the means (or apparatuses, elements and so on)” of the present invention means all or a part the functions of the above described means, and the above “operations of the steps (or processes, workings, actions and so on)” of the present invention means all or a part of the operations of the above described steps.

In addition, a form of using the program of the present invention may be the form recorded on the record medium readable by the computer and operating in synergy with the computer.

In addition, a form of using the program of the present invention may be the form transmitted in a transmission medium and read by the computer to operate in synergy with the computer.

In addition, the data structure of the present invention includes a database, a data format, a data table, a data list, a data type and so on.

In addition, the record media include an ROM and so on, and the transmission media include the transmission medium such as the Internet, light, a radio wave, a sound wave and so on.

In addition, the above described computer of the present invention is not limited to pure hardware such as a CPU, but may include firmware, an OS and peripherals on top of them.

Moreover, as described above, the configuration of the present invention may be implemented either software-wise or hardware-wise.

As is clear from the above description, the present invention has an advantage of being able to shorten the waiting time until the reproduction of the video file and audio file on the reproducing apparatus can be started.

1. A recording and reproducing system, comprising:
a record medium for holding a data file for storing predetermined data and parameter information used to reproduce said predetermined data;
parameter information recording means of recording said parameter information in a parameter information file for storing said parameter information held in said record medium; and
data reproducing means of reproducing the predetermined data stored in said data file by using said recorded parameter information.

2. The recording and reproducing system according to claim 1, wherein said parameter information recording means extracts the parameter information from said data file and records the extracted parameter information in said parameter information file.

3. The recording and reproducing system according to claim 1, wherein the parameter information stored in said data file is also stored in a predetermined location, and said parameter information recording means obtains said parameter information also stored in the predetermined location and records the obtained parameter information in said parameter information file.

4. The recording and reproducing system according to any one of claims 1 to 3, wherein said record medium holds a plurality of said data files, and said parameter information file stores all of the parameter information stored in said plurality of data files respectively.

5. The recording and reproducing system according to claim 4, wherein said plurality of data files are given unique data file IDs respectively by using order in which said parameter information file stores said parameter information.

6. The recording and reproducing system according to claim 5, wherein said data files have positions in which they are held by said record medium managed by using said given unique data file IDs.

7. The recording and reproducing system according to claim 4, wherein said parameter information file stores the parameter information stored in said plurality of data files respectively by using classification according to a type of said predetermined data.

8. The recording and reproducing system according to any one of claims 1 to 3, wherein said data file further stores meta-data information on said predetermined data, and meta-data information recording means of recording said meta-data information in a meta-data information file for storing said meta-data information held in said record medium is further provided.

9. A recording apparatus, comprising: parameter information recording means of recording parameter information in a parameter information file for storing said parameter information, said file held in a record medium for holding a data file for storing predetermined data and said parameter information used to reproduce said predetermined data,
wherein the predetermined data stored in said data file is reproduced by using said recorded parameter information.

10. A reproducing apparatus, comprising: data reproducing means of reproducing predetermined data stored in a data file by using parameter information recorded in a parameter information file held by a record medium for holding said data file for storing the predetermined data and the parameter information used to reproduce said predetermined data and the parameter information file for storing said parameter information.

11. A record medium for holding a data file for storing predetermined data and parameter information used to reproduce said predetermined data and a parameter information file for storing said parameter information,
wherein said parameter information is recorded in said parameter information file, and
the predetermined data stored in said data file is reproduced by using the parameter information stored in said parameter information file.

12. A recording and reproducing method, comprising:
a parameter information recording step of recording parameter information in a parameter information file held by a record medium for holding a data file for storing predetermined data and the parameter information used to reproduce said predetermined data and a parameter information file for storing said parameter information; and
a data reproducing step of reproducing the predetermined data stored in said data file by using said recorded parameter information.

13. A recording method comprising a parameter information recording step of recording parameter information in a parameter information file for storing said parameter information held by a record medium for holding a data file for storing predetermined data and said parameter information used to reproduce said predetermined data,
wherein the predetermined data stored in said data file is reproduced by using said recorded parameter information.

14. A reproducing method comprising a data reproducing step of reproducing predetermined data stored in a data file by using parameter information recorded in a parameter information file held by a record medium for holding said data file for storing the predetermined data and the parameter information used to reproduce said predetermined data and the parameter information file for storing said parameter information.

15. A program for causing a computer to execute parameter information recording step and data reproducing step of a recording and reproducing method according to claim 12.

16. A program for causing a computer to execute a parameter information recording step of a recording method according to claim 13.

17. A program for causing a computer to execute a data reproducing step of a reproducing method according to claim 14.

18. A medium supporting a program according to claim 15 and processable by a computer.

19. A medium supporting a program according to claim 16 and processable by a computer.

20. A medium supporting a program according to claim 17 and processable by a computer.
